(19) United States
(12) Patent Application Publication
(10) Pub. No.: US 2007/0031645 A1
(43) Pub. Date: Feb. 8, 2007

(54) Roll processed decorative laminate construction

(76) Inventors: J. Christopher Wilde, Mill Creek, WA (US); Brian J. Wimer, Bothell, WA (US); Kris E. Langkow, Snohomish, WA (US)

Correspondence Address: HARNESS DICKEY & PIERCE, PLC, P.O. BOX 828, BLOOMFIELD HILLS, MI, 48303, US

(21) Appl. No.: 11/194,744

(22) Filed: Aug. 1, 2005

Related U.S. Application Data
(60) Provisional application No. 60/688,414, filed on Jun. 8, 2005.

(51) Int. Cl. B32B 3/00

(52) U.S. Cl. 428/204

(57) ABSTRACT

A decorative printed decorative laminate for forming an interior surface within a mobile platform or fixed structure. The printed decorative laminate is adapted to be formed through roll processing, and includes a first film layer. An ink layer disposed adjacent to the first film layer. A second film layer is disposed adjacent to the ink layer, and an adhesive layer is disposed on a surface of the second film layer. The adhesive layer secures the first film layer to the second film layer. The adhesive layer can be a pressure sensitive adhesive, a heat-activated adhesive, a thermoset adhesive or combinations thereof for adhering the film layers together during the roll-forming operation. The present invention thus improves the efficiency and reduces the cost of forming a decorative printed decorative laminate by avoiding the batch operations and use of various chemicals typically employed to form multi-layer decorative panels.

### CROSS-REFERENCE TO RELATED APPLICATIONS

This application is related in general subject matter to U.S. patent application Ser. No. 10/656,090 filed Sep. 5, 2003, presently pending, assigned to The Boeing Company, and hereby incorporated by reference into the present application. The subject matter of the present application is also related to pending application U.S. patent application Ser. No. 10/882,047 filed Jun. 30, 2004, the disclosure of which is also hereby incorporated by reference. Finally, the subject matter of the present application is related generally to U.S. Provisional Patent Application Ser. No. 60/688,414, entitled “Method and Apparatus for Forming a Laminate Panel with Improved Fire Worthiness,” presently pending, the disclosure of which is also hereby incorporated by reference into the present application.

### FIELD OF THE INVENTION

The present invention relates to printed decorative laminates, and more particularly to a system and method for constructing printed decorative laminates through roll processing.

### BACKGROUND OF THE INVENTION

Certain mobile platforms, such as aircraft, trains and automobiles, may generally employ panel structures to form various interior surfaces. In many cases these panel structures are covered with printed decorative laminates to provide visually appealing surfaces to the objective viewer. Such printed decorative laminates generally have excellent wear, strength and fireworthy characteristics. For example, in a commercial aircraft, pluralities of lightweight composite sidewall panels are typically included along the port and starboard sides of the passenger cabin of the aircraft. These sidewall panels each generally include a printed decorative laminate disposed on the front of the sidewall panel to create a visually appealing interface for the customer. In addition, many other surfaces may be covered with printed decorative laminates to increase the visual appeal of the surface, such as stowage bin doors, ceiling panels and the like. Further, in some instances, printed decorative laminates may also be used to display information to potential viewers, such as safety hazards, emergency exit instructions or advertising/promotional messages.

Currently, printed decorative laminates are formed through batch operations in order to consolidate various material layers and impart texture onto its outer surface (i.e., the surface visible to an individual). These batch operations tend to be labor intensive and time consuming. In addition, due to the nature of the batch process itself, large quantities of consumable materials must typically be employed, which may result in waste. Accordingly, it would be highly desirable to create printed decorative laminates through the utilization of a pre-textured film layer and a more efficient consolidation technique. Such a process would significantly reduce the time and labor required to produce printed decorative laminates.

### SUMMARY OF THE INVENTION

The present invention is directed to a printed decorative laminate for a surface and a method for making the printed decorative laminate through roll-processing. The printed decorative laminate includes a pre-textured first film layer and an ink layer disposed adjacent to the first film layer. At least a portion of the first film layer is printed with ink. An adhesive layer is disposed on a surface of a second film layer. The adhesive layer secures the printed first film layer to the second film layer. The adhesive layer may be selected from the group comprising a pressure sensitive adhesive, heat activated adhesive, a thermoset adhesive or combinations thereof to facilitate consolidation of the layers.

### BRIEF DESCRIPTION OF THE DRAWINGS

The present invention will become more fully understood from the detailed description and the accompanying drawings, wherein:

FIG. 1 is a simplified perspective view of a portion of an interior area of a mobile platform illustrating a plurality of printed decorative laminates applied to selected surfaces, in this example overhead stowage bin doors, in accordance with a preferred embodiment of the present invention;

FIG. 1a is a perspective view of the interior area of the mobile platform showing printed decorative laminates applied to selected bin doors according to an alternative implementation of the present invention;

FIG. 2 is a cross sectional view of a printed decorative laminate taken in accordance with section line 2-2 in FIG. 1 showing the various layers comprising the printed decorative laminate;

FIG. 3 is a perspective view of a roller system used to implement a preferred method for forming the printed decorative laminate of FIG. 2, according to the present invention;

FIG. 4 is a perspective, environmental view of a method for applying the printed decorative laminate of FIG. 2 to a selected surface;

FIG. 5 is a side, cross sectional view of a printed decorative laminate having an alternative construction, taken along line 2-2 of FIG. 1, in accordance with an alternative preferred embodiment of the present invention; and

FIG. 6 is a side view of a method of forming the printed decorative laminate of FIG. 2 according to the principles of the present invention.

### DETAILED DESCRIPTION OF THE PREFERRED EMBODIMENTS

The following description of various embodiments is merely exemplary in nature and is in no way intended to limit the invention, its application, or uses. Although the following description is related generally to a roll processed printed decorative laminate construction for use as an interior decorative laminate in a mobile platform, such as an aircraft, train, ship, rotorcraft, or any other form of motor vehicle, it will be understood that the printed decorative laminate and method of forming described in the present application could just as easily be employed in fixed structures, such as conference rooms, or wherever the use of a decorative printed decorative laminate would be desirable. Therefore, it will be understood that the following discussion is not intended to limit the scope of the appended claims.

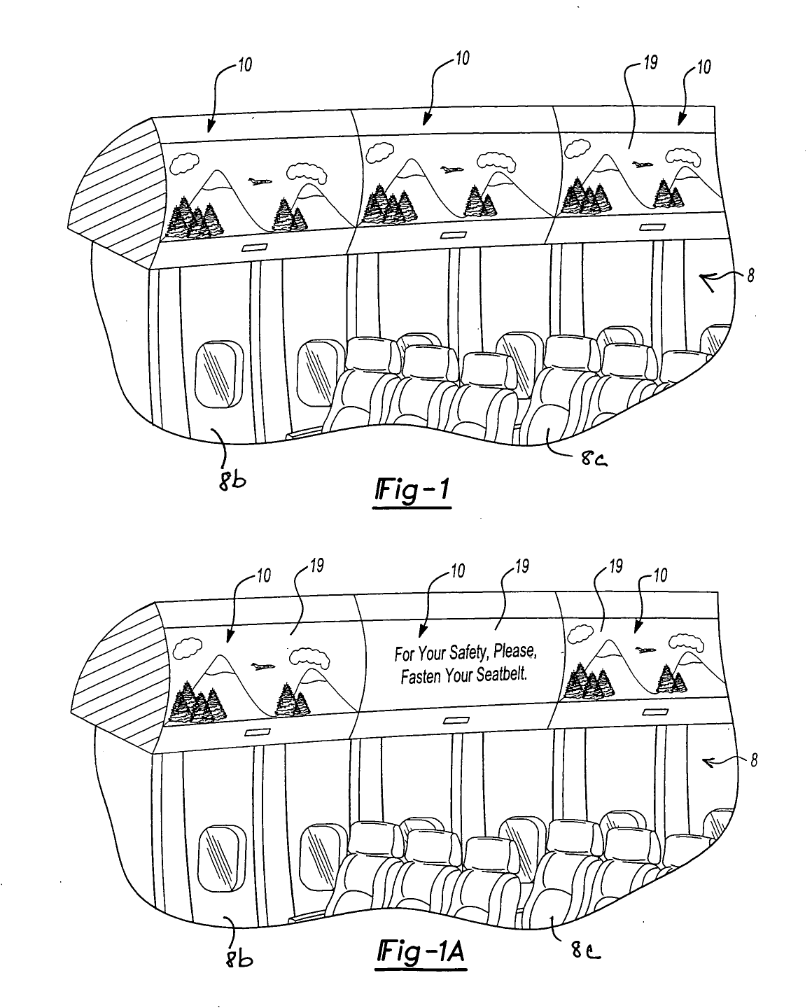

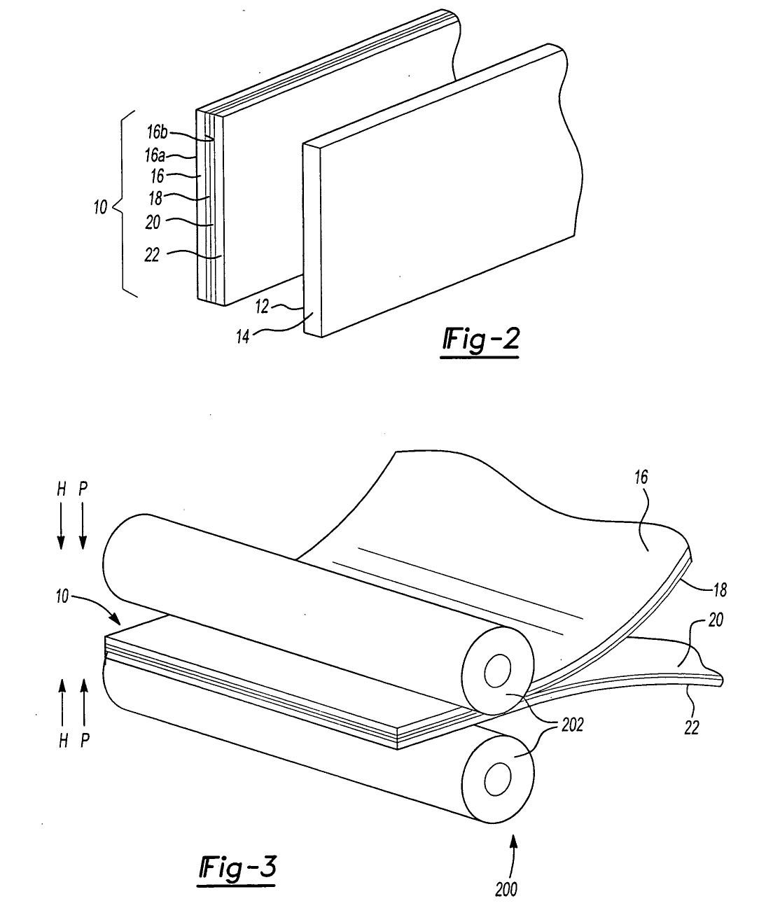

Referring to FIGS. 1, 1a and 2, a decorative printed decorative laminate 10 is shown. The printed decorative laminate 10, in this example, forms an outer surface 12 of a stowage bin door 14 in a mobile platform 8. The mobile platform, in this example, is a commercial aircraft having an interior cabin area 8a, wall portions 8b, seats 8c, ceiling panels (not shown), bulk heads (not shown) and various other well known structural components. In this example, interior cabin area 8a represents a passenger cabin area within a fuselage of the mobile platform. The printed decorative laminate 10 may include a first film layer 16. The first film layer 16 forms the outer layer of the printed decorative laminate 10. The first film layer 16 may be a pre-textured film with a texture similar to printed decorative laminates which are formed through batch operations. The first film layer 16 may comprise a thin polyvinyl fluoride film such as a Tedlar® PVF film having a thickness of preferably about 1.7 millimeters. The use of a Tedlar® PVF film increases the fire worthiness of the printed decorative laminate 10 due to the chemical composition of the Tedlar® PVF. The first film layer 16 is also preferably a clear gloss or a semi-gloss layer, but in either event it is substantially translucent. In addition, the first film layer 16 may also include an ultra-violet (UV) light blocking additive to prevent discoloration of the printed decorative laminate 10 from UV rays.

Adjacent to the first film layer 16 is an ink layer 18. For example, the printed decorative laminate 10 may be utilized for a single image 19 comprised of multiple printed decorative laminates 10, as shown in FIG. 1, or may comprise individual printed decorative laminates 10 each having a unique image or message 19, as shown in FIG. 1a. The image(s) 19 may comprise a decorative mural, an advertisement, or warnings, instructions and other information useful to occupants of the mobile platform 8. In this application, the ink layer 18 may comprise all or a portion of the image(s) 19 which may be printed by an ink jet printer on an inside surface 16b of the first film layer 16. In addition, the inside surface 16b of the first film layer 16 may be treated to improve the bonding of the ink thereto. One surface of the first film layer 16 may be treated to improve bonding by utilizing vacuum or atmospheric plasma treatment, corona treatment, or by applying a functional coating using atmospheric or vacuum coating equipment. As the first film layer 16 forms a protective covering for the ink, the first film layer 16 eliminates the need to place a protective, separate layer over the ink layer 18.

In the construction of the printed decorative laminate 10 with the ink layer 18, the ink layer 18 may be deposited by a suitable printer, and more preferably by a digital ink jet printer, on the first film layer 16. The ink used to form ink layer 18, which makes up the image(s) 19, preferably comprises an UV curable and stable ink (black or colored) that is deposited on the inside surface 16b of the first film layer 16. The ink 18 is cured virtually immediately after being deposited by the ink jet printer via a UV light operably associated with the digital ink jet printer that passes over the newly deposited ink as the ink is deposited. Companies making suitable ink jet printers or printing equipment are Vutek of Meredith, N.H. and Leggett & Platt Inc. of Jacksonville Beach, Fla. Other suitable inks are available from 3M Corp. of Minneapolis, Minn., and Sunjet of Bath, England. The ability of the UV curable ink to be cured virtually immediately after being deposited on the first film layer 16 also simplifies and expedites the manufacturing of the printed decorative laminate 10. In addition, UV curable inks allow ink loadings on the Tedlar® PVF in excess of 300% which is difficult, or impossible, to obtain using water or solvent based digital ink jet inks. Also, since the ink layer 18 is deposited on the inside surface 16b, it will be appreciated that the image 19 will need to be transposed during the printing process so that it appears correct when being viewed from the opposite side (i.e., outer surface 16a) of first film layer 16.

Adjacent to the ink layer 18 may be an adhesive layer 20. The adhesive layer 20 may be applied initially to a second film layer 22, as will be discussed in greater detail below. The adhesive layer 20 may generally be a pressure sensitive adhesive, a heat activated adhesive, or a thermoset adhesive. The general characteristics of these adhesives are flexibility, UV stability, fire resistance, an opaque white or clear appearance, high bond strength, and a processing temperature range from 225 degrees F. to 280 degrees F. The type of adhesive used, whether pressure sensitive, heat activated or thermoset, will determine the type of roll processing steps employed, as will be discussed in greater detail below. The adhesive layer 20 is used to secure the second film layer 22 to the first film layer 16.

The second film layer 22 is preferably disposed against the adhesive layer 20. The second film layer 22 also preferably comprises a polyvinyl fluoride film, such as Tedlar® PVF, which is preferably opaque or white in color to form a suitable background against which the colors of the ink layer 18 stand out. However, it will be appreciated that other background colors could be employed besides white or opaque, depending upon the desired color scheme.

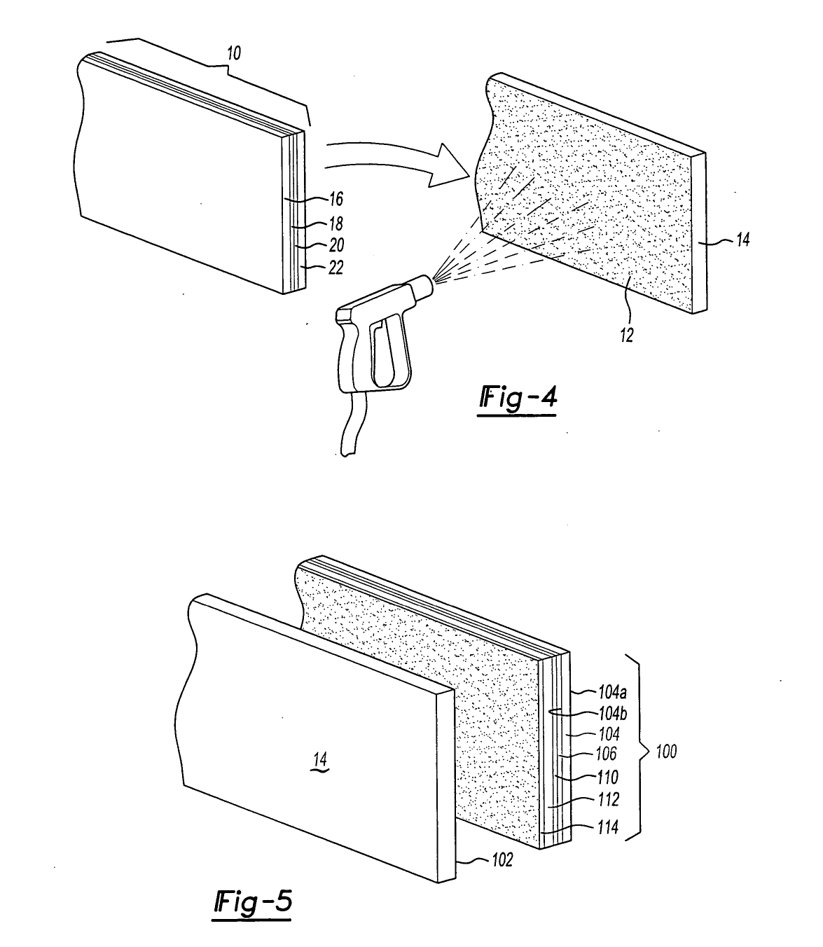

With continuing reference to FIGS. 1, 1a and 2, and additional reference to FIG. 3, in order to form the printed decorative laminate 10, the first printed film layer 16 may be secured to the second film layer 22 by a roll or belt laminator 200 using heat and/or pressure, depending upon the material selected for the adhesive layer 20. The term “laminator” is used to denote any equipment capable of applying sufficient heat and/or pressure simultaneously to the printed first film layer 16 and second film layer 22 to bond the film layers together to form the printed decorative laminate 10. The laminator 200 may comprise a pair of rollers 202 that apply pressure “P” and/or heat “H” to the first film layer 16 and second film layer 22. If the adhesive layer 20 is formed using either a thermoset or heat activated adhesive, the laminator 200 will simultaneously apply heat and pressure to bond the printed first film layer 16 to the second film layer 22. If, however, the adhesive layer 20 is formed using the pressure sensitive adhesive, then the laminator 200 will only need to apply pressure to bond the printed first film layer 16 to the second film layer 22. Once the printed first film layer 16 is bonded to the second film layer 22, the printed decorative laminate 10 may then be secured to any desired substrate surface 12 though the application of, for example, a spray adhesive as shown in FIG. 4, and then the use of an infrared (IR) oven to vacuum form the laminate to the desired surface. Some trimming of excess material or edge wrapping of laminate 10 may be required to achieve maximum aesthetic appeal.

With the embodiment shown in FIG. 1, the printed decorative laminates 10 each form integral portions of the image 19. The image 19 can be changed quickly and easily simply by removing the bin doors 14 that have the image 19 thereon and substituting a different set of bin doors 14 with different images (not specifically shown) formed of different printed decorative laminates 10. In addition, each of the printed decorative laminates 10 may provide a complete image 19 individually, as shown in FIG. 1a. In this instance, a given image 19 can be changed by removing its associated bin door 14.

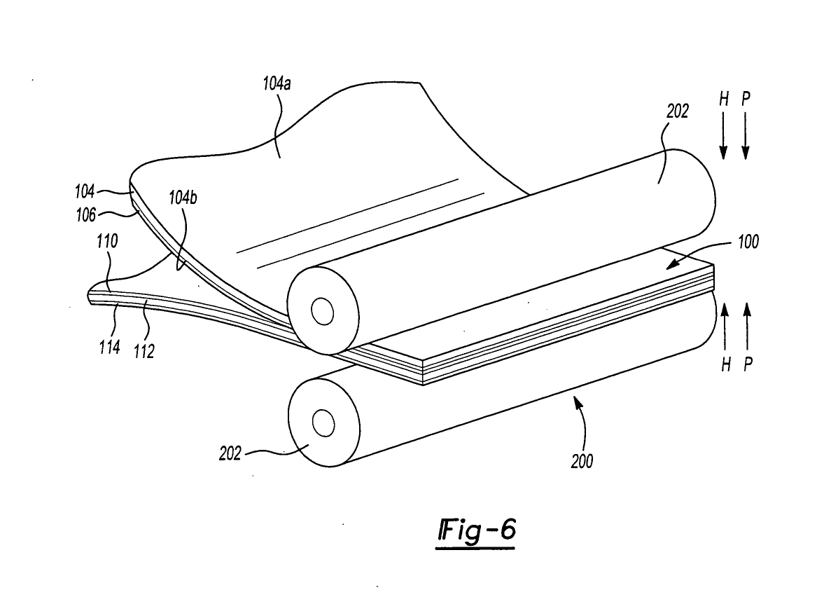

Referring to FIG. 5, there is shown an alternative preferred form of printed decorative laminate 100 that is strippable from an associated surface 102 of a given bin door 14. With this embodiment the image 19 can be changed simply by removing the bin doors 14 that have the image 19 thereon, and then with the use of a heat gun, remove the decorative laminate 100 from their respective surfaces 102, and then applying a new strippable printed decorative laminate 100 having a different image (not specifically shown).

In FIG. 5, the printed decorative laminate 100 can be seen to be similar in construction to printed decorative laminate 10. The printed decorative laminate 100 may include a first film layer 104. The first film layer 104 is generally the outer layer of the printed decorative laminate 100. The first film layer 104 may be a pre-textured film to facilitate roll forming, as will be described in greater detail below. The first film layer 104 may comprise a thin polyvinyl fluoride film such as a Tedlar® PVF film having a thickness of preferably about 1.7 millimeters. The first film layer 16 is also preferably a clear gloss or a semi-gloss layer, but in either event it is substantially translucent. In addition, the first film layer 16 may also include an ultra-violet (UV) light blocking additive to prevent discoloration of the printed decorative laminate 100 from UV rays.

Adjacent to the first film layer 104 is an ink layer 106. For example, the printed decorative laminate 100 may be utilized for an advertising mural or to provide warnings, instructions or other information to occupants, as illustrated previously in FIGS. 1 and 1a. In this application, the ink layer 106 may comprise all or a portion of the image 19 which may be printed by an ink jet printer on an inside surface 104b of the first film layer 104. In addition, the inside surface 104b of the first film layer 104 may be treated to improve the bonding of the ink. Methods to improve ink bonding to surface 104b may be vacuum or atmospheric plasma treatment, corona treatment, or by applying a functional coating using atmospheric or vacuum coating equipment. As the first film layer 104 forms a protective covering for the ink, the first film layer 104 eliminates the need to place a protective, separate layer over the ink layer 106.

The printed decorative laminate 100 includes the ink layer 106. Ink layer 106 may be deposited by a suitable printer, and more preferably by a digital ink jet printer. The ink used to form ink layer 106, which makes up the image, preferably comprises an UV curable and stable ink (black or colored) that is deposited on the first film layer 104, as discussed previously. The ability of the UV curable ink to be cured virtually immediately after being deposited on the first film layer 104 also simplifies and expedites the manufacturing of the printed decorative laminate 100. Also, since the ink layer 106 is deposited on the inside surface 104b, it will be appreciated that the image 19 will need to be transposed during the printing process so that it appears correct when being viewed from the opposite side (i.e., outer surface 104a) of first film layer 104.

Adjacent to the ink layer 106, may be an adhesive layer 110. The adhesive layer 110 may be applied initially to a second film layer 112, as will be discussed in greater detail below. The adhesive layer 110 may generally be a white or clear, pressure sensitive adhesive, heat activated adhesive, or thermoset adhesive, as described herein. The type of adhesive used, whether pressure sensitive, heat activated or thermoset, will determine the type of roll processing steps employed, as will be discussed in greater detail below.

The second film layer 112 is preferably disposed against the adhesive layer 110. The second film layer 112 also preferably comprises a polyvinyl film, such as Tedlar® PVF, which is preferably opaque or white in color to form a suitable background against which the colors of the ink layer 106 stand out. Other colors could also be employed. As stated previously, the use of a Tedlar® PVF film increases the fire worthiness of the printed decorative laminate 100.

In the construction of the strippable printed decorative laminate 100, a second adhesive layer 114 is disposed adjacent to the second film layer 112. The second adhesive layer 114 is generally comprised of a thermoplastic adhesive. The adhesive preferably has general characteristics such as fire resistance, high strength, and a processing temperature range of about 180 F to 225 F. A thermoplastic adhesive with these characteristics enables the printed decorative laminate 100 to be bonded to the desired surface 102 at a later time, and then removed later from the surface 102. The use of a thermoplastic adhesive also ensures that if the second adhesive layer 114 softens or liquefies during the formation of the printed decorative laminate 100, the second adhesive layer 114 will solidify when cooled after the manufacture of the printed decorative laminate 100 to enable adhesion at a later time. The thermoplastic second adhesive layer 114 ensures that the printed decorative laminate 100 may be applied to the surface 102 of any given bin door 14 at a later time.

The strippable printed decorative laminate 100 is formed similarly to the printed decorative laminate 10. The printed first film layer 104 may be bonded to the second film layer 112 by the roll or belt laminator 200 using heat and/or pressure, depending upon the material selected for the adhesive layer 110, as discussed previously. If the adhesive layer 110 is either a thermoset or heat activated adhesive, the rollers 202 of the laminator 200 will apply heat and pressure to bond the printed first film layer 104 to the second film layer 112. If, however, the adhesive layer 110 is a pressure sensitive adhesive, then the rollers 202 of the laminator 200 may only need to apply pressure to bond the printed first film layer 104 to the second film layer 112. Since the second adhesive layer 114 is a thermoplastic adhesive, if heat is used to bond the film layers 104 and 112, the second adhesive layer 114 may soften or liquefy, but the second adhesive layer 114 will solidify when cooled to enable adhesion at a later time. Once the film layers 104 and 112 are bonded together, the printed decorative laminate 100 may then be secured to any desired surface 102 through the use of an infrared (IR) oven to vacuum form the laminate to the desired surface. Some trimming of excess material or edge wrapping of laminate 100 may be required to achieve maximum aesthetic appeal.

Stripping an installed printed decorative laminate 100 from its associated surface 102 can be accomplished simply by heating the printed decorative laminate 100 with a heat gun or other like implement (not shown). Once heated sufficiently, the printed decorative laminate 100 can be peeled off of its associated surface 102. Typically there will be little or no residue left behind on the surface 102. Any residual adhesive that may be left can be easily and quickly cleaned with a mild cleaning detergent, or possibly soapy water. The surface 102 of the given bin door 14 is then ready to receive a new printed decorative laminate comprising a new image.

The apparatus and method of the present invention thus enables printed decorative laminates 10, 100, either with or without at least a portion of an image 19, to be constructed using a roll or belt laminator, resulting in the elimination of the batch operations typically associated with the formation of printed decorative laminates 10, 100. Hence, the present invention provides a more economical printed decorative laminate 10, 100 while creating printed decorative laminates 10, 100 which are substantially identical to those formed through batch operations due to the use of the pre-textured first film layer 16, 104 and adhesive layer 20, 110. By eliminating the batch operations, the formation of printed decorative laminates 10, 100 is made significantly more efficient and cost effective. Also, the production of byproducts that typically result from conventional printed decorative laminate construction processes is avoided or reduced.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

What is claimed is:

1. A decorative laminate for application to a surface of a structure, the laminate, comprising:
a first film layer;
an ink layer disposed adjacent to the first film layer;
an adhesive layer disposed adjacent to the ink layer; and
a second film layer disposed adjacent to the adhesive layer;
such that the layers are laminated together by a roll process.

2. The decorative laminate of claim 1, wherein the ink layer is printed on the first film layer prior to the laminating the layers together.

3. The decorative laminate of claim 1, wherein the adhesive layer is applied to the second film layer prior to laminating the layers together.

4. The decorative laminate of claim 1, wherein the second film layer has a pair of sides with the adhesive layer being adjacent to one of the sides of the second film layer, the decorative laminate further comprising a second adhesive layer disposed adjacent to the other side of the second film layer.

5. The decorative laminate of claim 1, wherein the film layers comprise roll film stock.

6. The decorative laminate of claim 1, wherein the adhesive layer comprises a heat-activated adhesive such that the layers are laminated together in a roll process including heat and pressure.

7. The printed decorative laminate of claim 1, wherein the first film layer is substantially translucent and the second film layer is substantially opaque.

8. A printed decorative laminate adapted to be secured to a substrate surface, the printed decorative laminate adapted to be formed through roll processing, comprising:
a first film layer;
a second film layer disposed adjacent to the first film layer;
at least a portion of an image printed onto a surface of the first film layer;
an adhesive layer disposed on a surface of the second film layer and operable to adhere the first film layer to the second film layer to sandwich the image between the first film layer and second film layer upon receipt of at least one of heat and pressure applied during a roll-forming process; and
wherein the adhesive layer is selected from the group comprising a pressure sensitive adhesive, heat activated adhesive, a thermoset adhesive or combinations thereof to facilitate roll forming.

9. The printed decorative laminate of claim 8, wherein the first film layer and second film layer are comprised of a polyvinyl fluoride film.

10. The printed decorative laminate of claim 8, wherein the printed decorative laminate further comprises a thermoplastic adhesive layer disposed on an opposite surface of the second film layer.

11. The printed decorative laminate of claim 8, wherein the first film layer includes a pre-textured surface disposed on at least one surface of the first film layer.

12. The printed decorative laminate of claim 8, wherein the first film layer is substantially translucent.

13. The printed decorative laminate of claim 8, wherein the second film layer is substantially opaque.

14. A method for forming a decorative printed decorative laminate comprising:
providing a first film layer;
applying an adhesive layer to a first surface of the first film layer;
positioning a second film layer adjacent to the first surface of the first film layer; and
using at least one of heat and pressure to secure the first film layer to the second film layer.

15. The method of claim 14, further comprising:
applying a second adhesive layer to a second surface of the first film layer; and
securing the printed decorative laminate to a surface using the second adhesive layer.

16. The method of claim 14, further comprising:
using a roll laminator to apply the at least one of heat and pressure to secure the first film layer to the second film layer.

17. A mobile platform comprising:
an interior panel;
a printed decorative laminate adapted to be secured to said interior panel;
said printed decorative laminate including:
a first film layer;
an ink layer disposed adjacent to the first film layer;
an adhesive layer disposed adjacent to the ink layer;
a second film layer disposed adjacent to the adhesive layer; and
the layers being laminated together by a roll forming process including pressure.

18. A method of manufacturing a mobile platform comprising:
providing an interior panel for use within an interior area of a body portion of the mobile platform;
forming a printed decorative laminate for disposing against the interior panel, the printed decorative laminate being formed by:
providing a first film layer;
disposing an ink layer adjacent to the first film layer;
disposing an adhesive layer adjacent to the ink layer;
disposing a second film layer adjacent to the adhesive layer; and
laminating the layers together by using a roll forming operation that includes applying pressure to the layers.
